(19) United States
(12) Patent Application Publication
(10) Pub. No.: US 2019/0032625 A1
(43) Pub. Date: Jan. 31, 2019

(54) SYSTEMS AND METHODS FOR HYDROELECTRIC SYSTEMS INCORPORATING ARTIFICIAL BARRIERS WITH CROSS-FLOW TURBINES

(71) Applicant: DAYTON HYDRO ELECTRIC LTD., D/B/A KW RIVER HYDROELECTRIC, Hamilton, OH (US)

(72) Inventor: Paul Raymond Kling, Cincinnati, OH (US)

(21) Appl. No.: 16/019,201

(22) Filed: Jun. 26, 2018

Related U.S. Application Data
(60) Provisional application No. 62/537,115, filed on Jul. 26, 2017.

(51) Int. Cl. F03B 11/02; F03B 3/10; F03B 3/12

(52) U.S. Cl. CPC F03B 11/02; F03B 3/121; F03B 3/106

(57) ABSTRACT

Embodiments include a hydroelectric system including a module having a protective housing, a turbine housing retained within the protective housing, the turbine housing including an inlet portion at a first end, a substantially tubular portion, and an outlet portion at a second end, a turbine retained at least partially within the turbine housing, the turbine including a plurality of blades coupled with a central shaft, and a hydraulic pump, the hydraulic pump being coupled with the central shaft, where the hydraulic pump is configured to pump a high pressure liquid, and an artificial barrier, the module being coupled to a downstream surface of the artificial barrier, where the artificial barrier defines a cutout having an inlet portion, an outlet portion, and a channel fluidly coupled with the turbine housing of the module.

### CROSS REFERENCE TO RELATED APPLICATION

The present application claims the priority of U.S. provisional application Ser. No. 62/537,115, entitled SYSTEMS AND METHODS FOR HYDROELECTRIC SYSTEMS INCORPORATING ARTIFICIAL BARRIERS WITH CROSS-FLOW TURBINES, filed Jul. 26, 2017, and hereby incorporates the same application herein by reference in its entirety.

### TECHNICAL FIELD

Embodiments of the technology relate, in general, to hydroelectric technology, and in particular to hydroelectric systems that can be used to generate power from artificial barriers associated with at least one cross-flow turbine.

### BRIEF DESCRIPTION OF THE DRAWINGS

The present disclosure will be more readily understood from a detailed description of some example embodiments taken in conjunction with the following figures:

FIG. 1 depicts a perspective view of an HPPM module according to one embodiment.

FIG. 2 depicts a perspective partially exploded view of the HPPM module depicted in FIG. 1.

FIG. 3 depicts a left side cross-sectional view of the HPPM module depicted in FIG. 1 shown adjacent an artificial barrier according to one embodiment.

FIG. 4 depicts a perspective view of an HPPM module according to one embodiment.

FIG. 5 depicts a perspective view of a system of interconnected modules shown associated with a land-based generator or offsite generator according to one embodiment.

FIG. 6 depicts a perspective view of a system of interconnected modules shown coupled with an artificial barrier according to one embodiment.

FIG. 7 depicts a perspective view of a system having a single HPPM module associated with a single artificial barrier, where the single HPPM module includes a plurality of turbines connected to a shaft according to one embodiment.

FIG. 8 depicts a front perspective view of the HPPM module of FIG. 3, shown with a protective grate according to one embodiment.

FIG. 9 depicts a front perspective view of the HPPM module of FIG. 3, shown with a flow control bladder according to one embodiment.

FIG. 10 depicts a perspective view of a plurality of artificial barriers having associated HPPM modules, where the artificial barriers and associated modules are shown in a staged configuration.

### BACKGROUND

Renewable energy resources are gaining global attention due to depleting fossil fuels and harmful environmental effects associated with their usage. Hydro, wind, solar, biomass and geothermal energies form the bulk of renewable energy sources; among which hydro power may offer one of the more sustainable propositions. Traditionally, hydro power has accounted for the bulk of the renewable energy production in the United States.

### SUMMARY

Embodiments include a hydroelectric system include a module having a protective housing, a turbine housing retained within the protective housing, the turbine housing including an inlet portion at a first end, a substantially tubular portion, and an outlet portion at a second end, a turbine retained at least partially within the turbine housing, the turbine including a plurality of blades coupled with a central shaft, and a hydraulic pump, the hydraulic pump being coupled with the central shaft, where the hydraulic pump is configured to pump a high pressure liquid, and an artificial barrier, the module being coupled to a downstream surface of the artificial barrier, where the artificial barrier defines a cutout having an inlet portion, an outlet portion, and a channel fluidly coupled with the turbine housing of the module.

Embodiments include a hydroelectric system having a module including a turbine housing, the turbine housing including an inlet at a first end, a substantially tubular portion, and an outlet at a second end, a turbine retained at least partially within the turbine housing, the turbine including a plurality of blades coupled with a central shaft, and a fluid pump, the hydraulic pump being coupled with the central shaft, where the hydraulic pump is operably configured to pump a high pressure liquid, and an artificial barrier, the module being coupled to a downstream surface of the artificial barrier, where the artificial barrier defines a cutout having an inlet portion, an outlet portion, and a channel fluidly coupled with the turbine housing of the module.

Embodiments include a method for operating a hydroelectric system including providing a module having a protective housing, a turbine housing retained within the protective housing, the turbine housing including an inlet portion at a first end, a substantially tubular portion, and an outlet portion at a second end, a turbine retained at least partially within the turbine housing, the turbine including a plurality of blades coupled with a central shaft, and a hydraulic pump, the hydraulic pump being coupled with the central shaft, wherein the hydraulic pump is configured to pump a high pressure liquid, and providing an artificial barrier, where the artificial barrier defines a cutout having an inlet portion, an outlet portion, and a channel, positioning the module adjacent a downstream surface of the artificial barrier such that the turbine housing of the module is fluidly coupled with the channel of the cutout, rotating the turbine with the fluid flowing through the cutout in the artificial barrier, and generating power in response to the rotation of the turbine.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for hydroelectric power generation. In one example embodiment, a hydroelectric power generator that can be deployed with an artificial barrier is disclosed. In some embodiments, the hydroelectric generator can produce power from both the pressure differential created by the artificial barrier, such as an aperture or cutout defined by the artificial barrier, as well as the flow velocity of the water channel. In some embodiments, the hydroelectric generator can be self-contained in a submersible module which can further be a hydraulic-hydrokinetic power production module (“HPPM”). In some embodiments, a system of hydroelectric generator systems or HPPMs can be deployed in a water channel to capture a larger amount of energy from the channel than one HPPM module can capture. In some embodiments, the hydroelectric generator module can generate electricity during the lowest flow-rate condition of a water source. In certain embodiments, the system can include a hydroelectric generator that can efficiently generate power in cooperation with an artificial barrier without ecologically destabilizing a water channel or requiring extensive reconfiguration of the installation site.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can beneficially capture energy from water channels during all flow conditions of the channel and can operate without detrimental effect to the water channel's ecology or environment. For example, the flow rate, appearance, and usability of the water channel by boats and wildlife can remain unaffected or substantially unaffected by operation of the generator modules, pump modules, and/or artificial barriers described herein. Traditional hydroelectric installations, in contrast, would require substantial reconfiguration of the river flow, permanent changes to ecological features, and impediments to recreational use. Additionally, the present hydroelectric generators, HPPM modules, and pump modules can be easily installed with common equipment. The generators, modules, and/or barriers can also be installed in such a way that they do not interfere or compromise the purpose of a river way or waterway. Such a configuration can generate pollution-free electricity. The installation of HPPMs on the downstream side of an artificial barrier may have no more of an environmental effect than that of a low head dam, or the like.

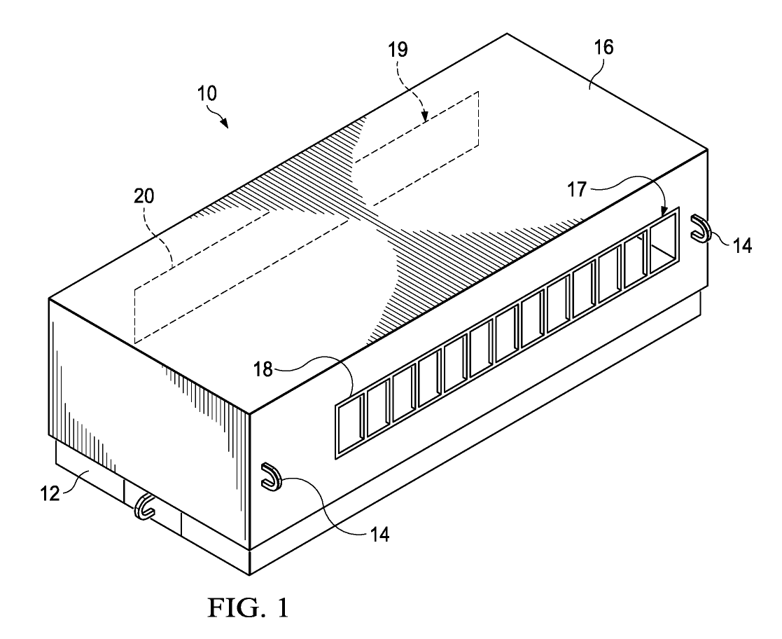

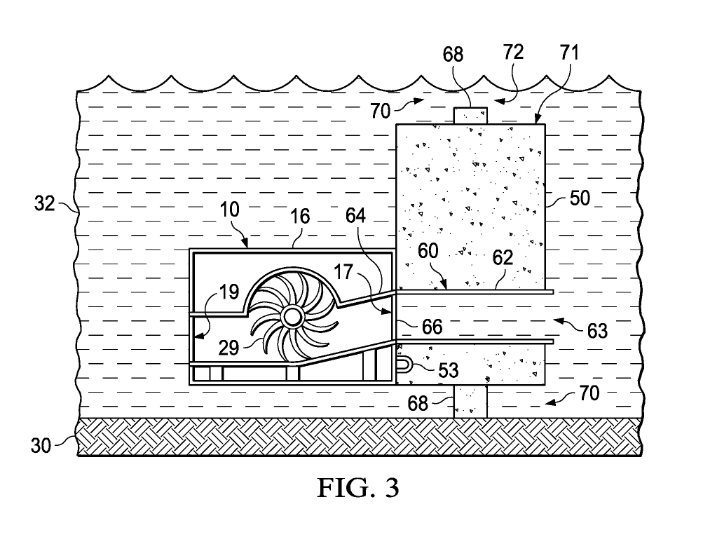

Referring now to FIG. 1, a HPPM module 10, which can be a turbine module, is depicted according to one embodiment. The HPPM module 10 can be water submersible and can be attached to, or adjacent to, an artificial barrier 50 (FIG. 3) when in use. The HPPM module 10 can be located on a platform 12, such as a concrete platform, for support. The platform 12 can also assist in installation of the HPPM module 10. For example, the platform 12 can assist in installation or removal of the HPPM module 10 by common moving equipment. In some examples, the platform 12 can include any suitable coupling member or member for attachment to the artificial barrier 50. The coupling members, such as mounting points 14, can include hooks, rings, or any other suitable coupling or connection. The artificial barrier 50 can include any suitable coupling member 53 that can cooperate with the mounting points 14, or the like, to selectively or permanently couple the HPPM module 10 with the artificial barrier 50. The generator modules can be designed for easy placement and removal from the artificial barrier 50 or, alternatively, the generator modules can be permanently affixed or integrally coupled with the artificial barrier 50. Any suitable anchoring method is contemplated such as bolted, weighted, wedged, cemented, hinged, or welded anchoring mechanisms, for example. In an alternate embodiment, the HPPM module 10 can be monolithically formed as a unitary, one-piece construction with the artificial barrier 50. Such a monolithic design may allow for a single installation within a waterway to set up the hydroelectric system.

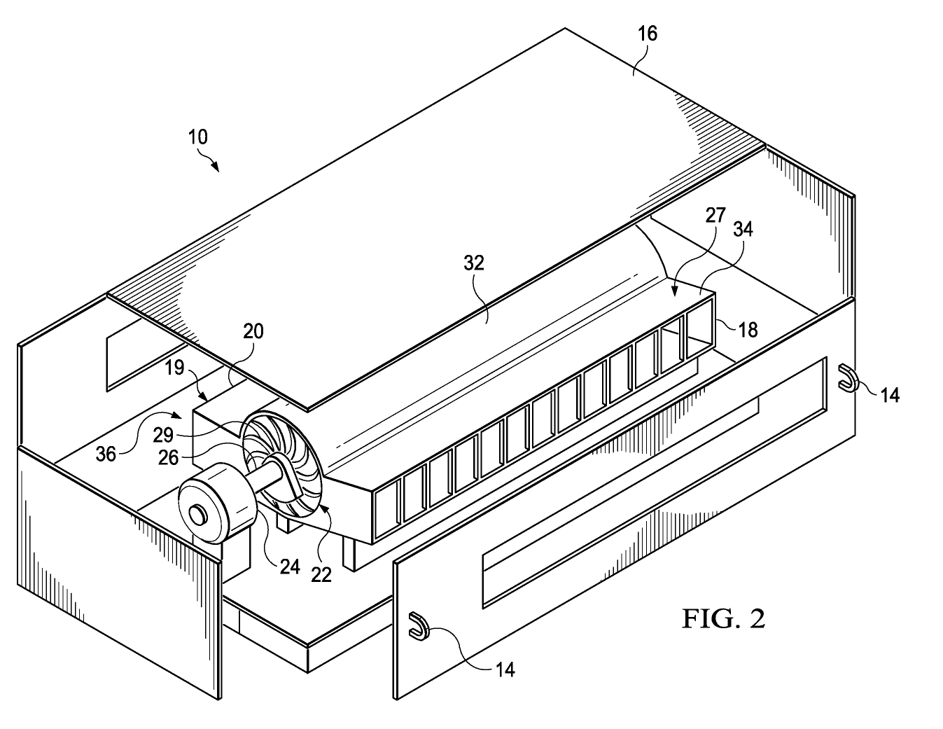

The HPPM module 10 can have a protective enclosure 16 that can protect internal components as well as wildlife and recreational users of waterways. The protective enclosure 16 can be configured to make the HPPM module 10 look like a part of the artificial barrier 50 to provide an aesthetically pleasing appearance. In one example, the protective enclosure 16 and the artificial barrier 50 can be concrete. In another example, the protective enclosure 16 and the artificial barrier 50 can be metal. In another example, the protective enclosure 16 and the artificial barrier 50 can be a composite material. The protective enclosure 16 can include a first opening 17 protected by an upstream grate 18 and a second opening 19 that can be protected by a downstream grate 20 to prevent debris from damaging the turbine and generator located inside. The first opening 17 can allow head water from the water channel to flow through the HPPM module 10 to produce electricity. Head water can exit the HPPM module 10 through the second opening 19 after flowing through the internal turbine 22 (FIG. 2). The first opening 17 can be substantially parallel or coaxial with the second opening 19 to match the directional flow of fluid through the artificial barrier 50 as illustrated in FIG. 3. The first opening 17 and second opening 19 can have the same dimensions or can be configured differently. The first opening 17 and second opening 19 can have a width of from about 1 inch to about 2 inches, from about 2 inches to about 12 inches, from about six inches to about 2 feet, from about 6 inches to about 18 inches, or any other suitable dimension. The first opening 17 can have a funnel shape or any other suitable shape for directing water into the HPPM module 10.

Any suitable protective enclosure 16 and/or artificial barrier 50 is contemplated. The protective enclosure 16 can substantially surround the turbine housing 27 (FIG. 2) and can provide debris protection, increase operational safety, enhance aesthetics, improve flow characteristics, and efficiency of the HPPM module 10. The protective housing 16 and/or the artificial barrier 50 can be mass produced, or can be designed to substantially match the flow characteristics of a particular waterway. The protective housing 16 and/or artificial barrier 50 can help protect aquatic biology and can prevent damage of the turbine that can be caused by such aquatic biology. The protective housing 16 and/or artificial barrier 50 can be metallic, aluminum plate, light weight, and low corrosion. The protective housing 16 can be steel plate that is cost effective and machinable. The protective housing 16 can be formed from metallic castings that are cost effective and reproducible at high production volumes. The protective housing 16 and/or artificial barrier 50 can include non-metallic, biologically inert materials that may improve environmental compatibility. Such materials can include recycled plastic, which may have the advantage of being low cost and environmentally friendly. Materials can include HDPE, XLPE, or other readily available, low cost materials with well-known properties. The protective housing 16 and/or artificial barrier 50 can include composite materials such as carbon fiber, which may have enhanced operational and component forming properties. Coatings (not shown) may provide additional debris protection, increase operational safety, enhance aesthetics, improve flow characteristics and efficiency, slow deterioration, and/or improve the protection of aquatic biology. The protective housing 16 and/or artificial barrier 50 coatings can include cementitious materials, which are generally inexpensive and can provide additional durability, carbon nanotube materials, which can prevent adherence of biologic material, and epoxies, resins, or enamels, which can add additional strength and corrosion resistance. In an alternate embodiment, the protective housing 16 can be absent. In an alternate embodiment, the HPPM module 10 can be incorporated directly into a body of the artificial barrier 50.

FIG. 2 depicts a partially exploded view of a HPPM module 10 according to one embodiment with the protective enclosure 16 removed. The HPPM module 10 can include a turbine 22 and a generator 24. The turbine 22 can be operationally similar to a water wheel and can include any number of turbine blades 29 that can project radially outward from a central shaft 26. In one example, the turbine 22 can include six blades. In another example, a turbine 22 can include nine blades. In another example, a turbine 22 can include twelve, or more blades. The generator 24 can be a variable capacity generator that can operate over a range of water flow velocities. The generator 24 can be directly coupled to the central shaft 26 of the turbine 22 or the generator 24 can alternatively be connected to an intermediary gearbox (not shown). The turbine 22 and generator 24 can operate at relatively slow speeds to prevent damage to the ecosystem. For example, the turbine can operate at from about 20 to about 100 rotations per minute (RPM), from about 30 to about 60 RPM, at less than about 50 RPM, at 60 RPM, or at less than about 120 RPM. The relatively low speed can also prevent the HPPM module 10 from causing fish kill. The overall efficiency of the generator module can be at least about 70%, at least about 75%, at least about 80%, at least about 85%, or at least about 90%. The turbine and generator can be coupled directly to the platform 12 for stability, can be coupled with the protective enclosure 16 that can be selectively removable from a platform 12 that is fixed, or alternatively can be coupled directly with a barrier such as an artificial barrier 50.

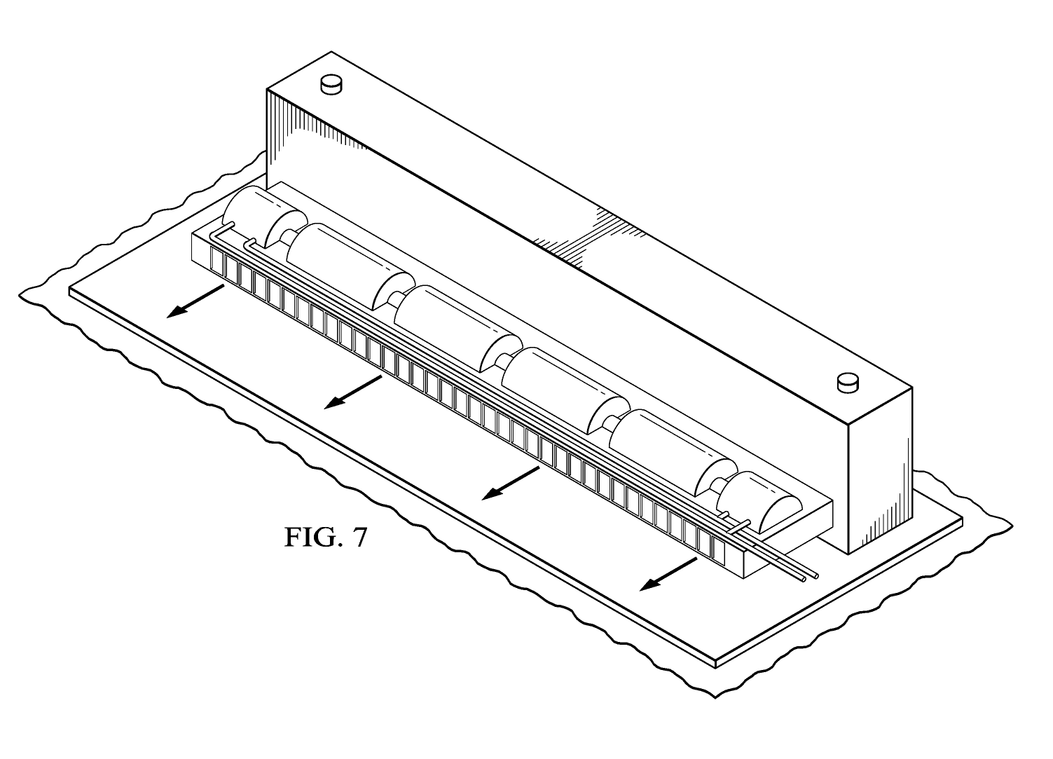

The HPPM module 10 can have any suitable structure for a central shaft 26. The central shaft 26 can be designed in sections from about 4 feet to about 10 feet in length, for example, along the shaft axis allowing each section to be constructed with the turbine blades 29 as a module and aligned and fitted in a turbine housing 27 with a total length ranging from about 6 feet to about 60 feet, for example. The central shaft 26 can be constructed of solid, tubular, or semi-solid metallic, non-metallic, or composite material. The central shaft 26 can be formed, cast, machined, extruded, or configured using any combination of these manufacturing methods. Adjacent axial shafts can be connected by any number of methods including, but not limited to, bolted flanges, flexible or mechanical couplings, welded joints, sleeve and key, or any combination of these mechanisms. Turbine shaft bearings (not shown) can be configured in any suitable manner from any suitable material such as utilizing specialized wood (Lignum Vitae) bearings, sealed steel roller or ball bearings, full contact malleable metallic materials, or full contact, malleable non-metallic materials. A small space or cutout (not shown) between the blades and shaft of the turbine can be provided to minimize the presence and effect of air bubbles. In an alternate embodiment, as shown in FIG. 7, a single shaft can be associated with a plurality of turbines spaced apart along a single artificial barrier.

The turbine 22 can be housed within the turbine housing 27, which can include a substantially tubular portion 32, an inlet portion 34, and an outlet portion 36. The substantially tubular portion 32 can be sized to accommodate any suitable turbine 22. It will be appreciated that the tubular portion 32 is described by way of example only, where any suitable shape is contemplated. The inlet portion 34 can include the upstream grate 18 and the outlet portion 36 can include the downstream grate 20. The inlet portion 34 can have any suitable size, shape, or configuration to direct the flow of fluid through the turbine housing 27 past the turbine 22. The inlet portion 34 can be substantially the length of the HPPM module 10, can be shorter than the length of the HPPM module 10, or can be wider or longer than the HPPM module 10 with a funnel (not shown) or other mechanism for drawing fluid into the turbine housing 27. The turbine housing 27 can include a plurality of inlet portions and/or a plurality of outlet portions having any suitable shape or configuration. In one embodiment, HPPM module 10 can have a flexible or pivotable protective enclosure 16 and/or turbine housing 27 such that the turbine housing 27 and/or protective enclosure 16 can be adjusted relative to the flow of water through the artificial barrier 50.

FIG. 3 depicts a side cross-sectional view of an HPPM module 10 and artificial barrier 50 according to one embodiment. The HPPM module 10 can be installed on the artificial barrier 50 such that it can collect substantially all of the water flowing through a cutout 60 defined by the artificial barrier 50. The cutout 60 can define an inlet portion 62, a channel 63, and an outlet portion 64. The cutout 60 can have a substantially uniform height, can form a funnel between the inlet portion 62 and the outlet portion 64, or can have any other suitable shape or configuration. As illustrated, the inlet portion 62 and the outlet portion 64 can be coplanar such that the channel 63 has a linear configuration. In alternate embodiments, it will be appreciated that the inlet portion and the outlet portion can be positioned at different relative heights on the artificial barrier such that the channel defined by the artificial barrier has a non-linear shape. For example, the channel can be L-shaped, can have a curved shape, or the like. It will be appreciated that the cutout 60 can include a plurality of cutouts or channels having a plurality of inlets and outlets that can pass through an artificial barrier at a plurality of locations. In one embodiment, the cutout 60 can be sized to facilitate a constant flow of fluid through the barrier 50. In one embodiment, the channel 64 can be operably sized to permit about 70% or the water from a waterway to flow through the channel 64. The inlet portion 62 can include a grate 66 that can include a grid of material, such as mesh, that can be sized to prevent debris, jetsam, and other unwanted material from entering the channel 63. The barrier 50 can be a cement wall or any other type of structure constructed from any suitable material, such as cementitious material, metal, ceramic, or the like.

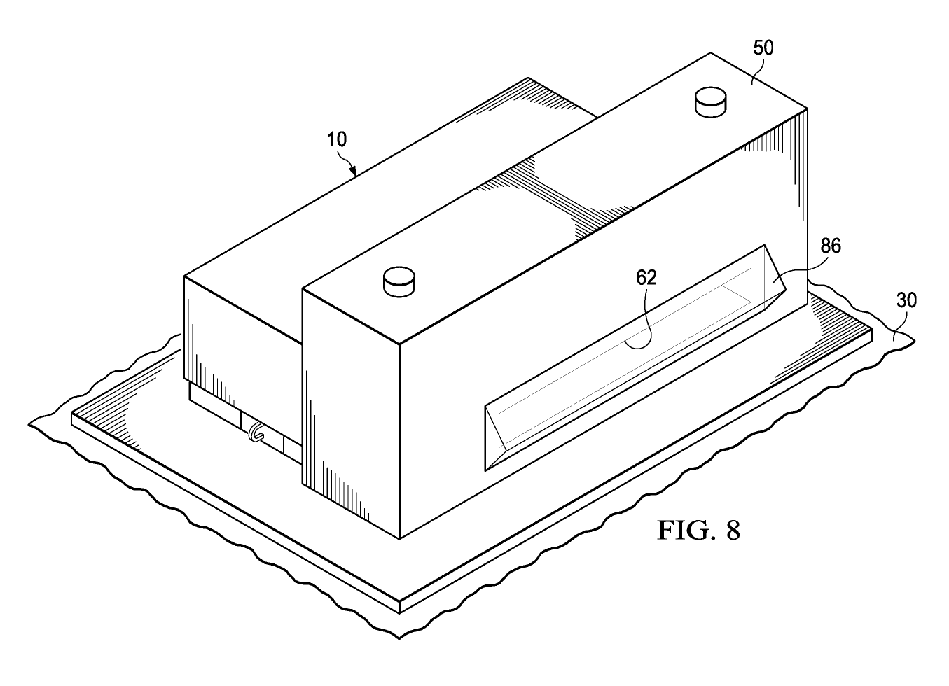

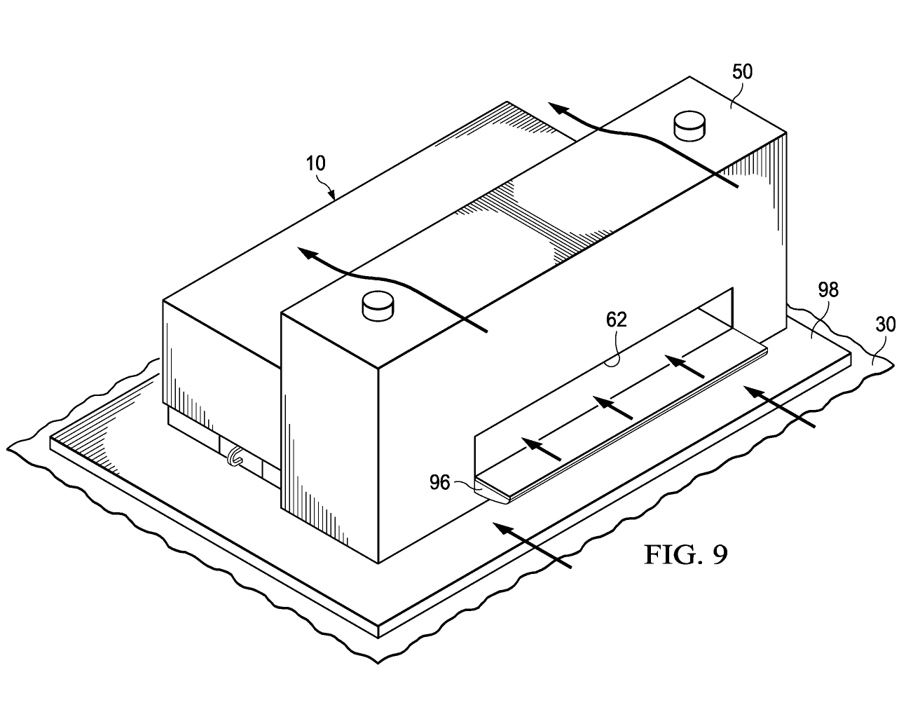

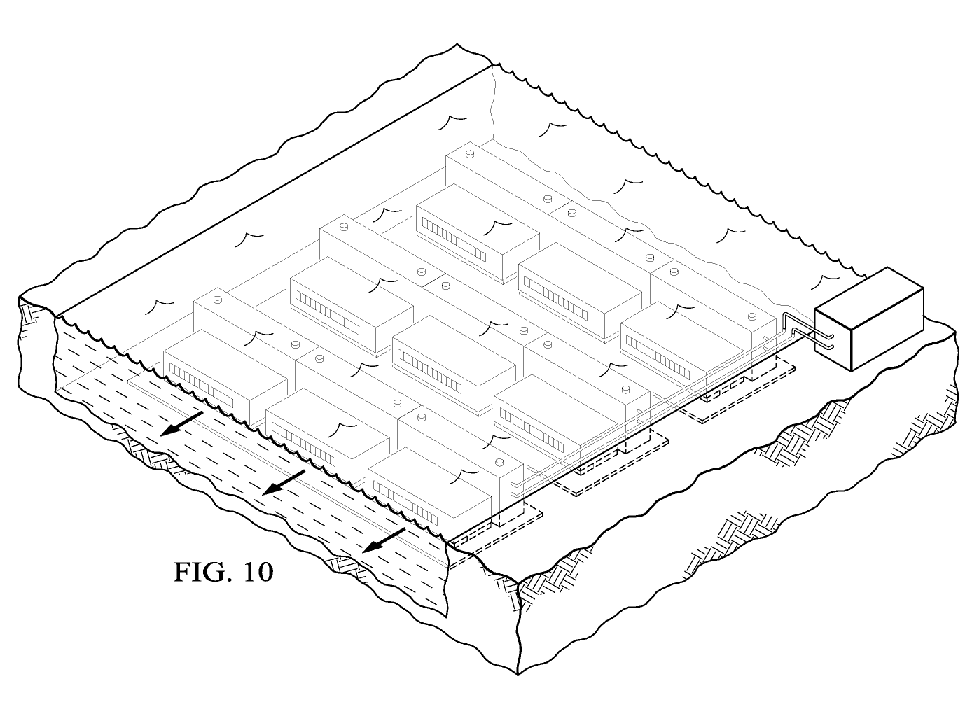

As illustrated in FIG. 3, the first opening 17 of the protective enclosure 16 and the inlet portion 34 of the turbine housing 27 can be aligned with the outlet portion 64 of the cutout 60. In this manner, water passing through the cutout 60 of the artificial barrier 50 can pass directly into the turbine housing 27 to drive the turbine 22 to generate power. In some examples, as shown in FIG. 8, a protective mesh 86 can be attached to an upstream surface of the artificial barrier 50 at about the inlet portion 62. The protective mesh 86 materials can prevent small debris from flowing into the generator module and causing damage. In an alternate embodiment, as shown in FIG. 9, a flow control bladder 96 can be associated with the inlet portion 62 of the artificial barrier 50. The flow control bladder 96 can be pressure activated to control the flow of water into the inlet portion 62. FIG. 10 also illustrates an anti-scouring pad 98 that can be installed on the water bed 30.

The artificial barrier 50 can have any suitable shape and construction. In the illustrated embodiment, the artificial barrier 50 can be a wall or similar structure having a generally vertical orientation that is substantially perpendicular to the fluid flow of a waterway. The artificial barrier 50 can be supported by at least one anchoring column 68 that can raise the bottom 69 of the anchoring column 68 off of the water bed 30 such that water or other fluid can flow beneath the artificial barrier 50. The bottom 69 of the anchoring column 68 can define a first gap 70 that can be sized to allow aquatic life, such as fish, to easily pass beneath the artificial barrier 50. The first gap 70 can have a height of, for example, about 2 feet, from about 1 foot to about 3 feet, or any other suitable height. In one embodiment, the artificial barrier 50 can be operably sized such that the first gap 70 permits about 10% of the water in the waterway to flow beneath the artificial barrier 50. of the In an alternate embodiment, the artificial barrier 50 can be flush with the bottom surface of a water bed 30, where the artificial barrier 50 may only extend across a portion of a waterway such that water can flow around the sides of the artificial barrier 50.

The artificial barrier 50 can be sized such that a top 71 of the artificial barrier 50 can be low enough that water from a waterway can flow over the top 71. In an example embodiment, the artificial barrier 50 can be sized such that about 20% of the water in the water way can flow over the top 71. The top 71 of the artificial barrier 50 and an upper surface of the waterway can cooperate to define a second gap 72 of water flow over the artificial barrier 50. The second gap 72 can be sized such that boaters, fish, or the like can pass over the top 71 of the artificial barrier 50. The second gap 72 can have a height of about 2 feet, from about 1 foot to about 3 feet, or any other suitable height. Because the second gap 72 may vary based upon the variable height of the waterway, it will be appreciate that the artificial barrier 50 can be sized to allow for boat passage, the travel of aquatic life, or the like, over the top 71 even at relatively low water levels. The top 71 of the artificial barrier 50 can be planar, can be rounded or curved to reduce the risk of injury to boaters, can be substantially smooth, or have any another other desirable shape or surface effect. The artificial barrier 50 can have any suitable thickness such as, for example, a thickness of about 6 inches, about 1 foot, from about six inches to about 2 feet, or any other suitable thickness. The artificial barrier 50 can be a planar wall or, in an alternative embodiment, can be non-planar such as a V-shaped configuration, a W-shaped configuration, a sinusoidal-shaped configuration, or the like.

Turbine blades 29 can be fabricated from any number of different materials using any number of machining or forming processes. In each case, a mathematical formula based on anticipated flow rate at the specific installation site can be used to determine the optimal blade shape and size as well as the number of blades comprising the turbine 22 for maximum efficiency versus production costs, installation costs, and full life-cycle costs. Blade curvature and number of blades can be mathematically optimized using the blade element momentum (BEM) theory, for example, over the anticipated flow range for maximum power transfer efficiency and acceptable life cycle economic costs. The BEM theory is described in more detail in Hydrodynamic Design and Optimization of Hydro-Kinetic Turbines using a Robust Design Method, by Nitin Kolekar, et al., Proceedings of the 1st Marine Energy Technology Symposium, Apr. 10-11, 2013, Washington, D.C., which is herein incorporated by reference in its entirety. Factors such as number of blades, tip speed ratio, type of airfoil, blade pitch, and chord length and twist can be considered. Flow range can be considered for maximum power transfer efficiency and acceptable life cycle economic costs. Turbine blades 29 can include metallic blades, such as aluminum blades, which can be plates, formed blades, cast blades, machined blades, bent blades, extruded blades, or the like, where such aluminum blades may be readily machineable and cost effective. Steel blades can be used that have high strength, low cost, and manufacturing familiarity. Brass or bronze blades can be used that can exhibit corrosion resistance. Non-metallic blades, such as carbon fiber composite and ceramic blades, can exhibit wear resistance and low life cycle costs. Plastics may have a low cost, high availability, and may be biologically inert, and can include HDPE, XLPE, recycled plastic, and laminates, singularly or in combination. It will be appreciated that any suitable combination of materials including wood, resins, plastics, metallic, and/or ceramic are contemplated.

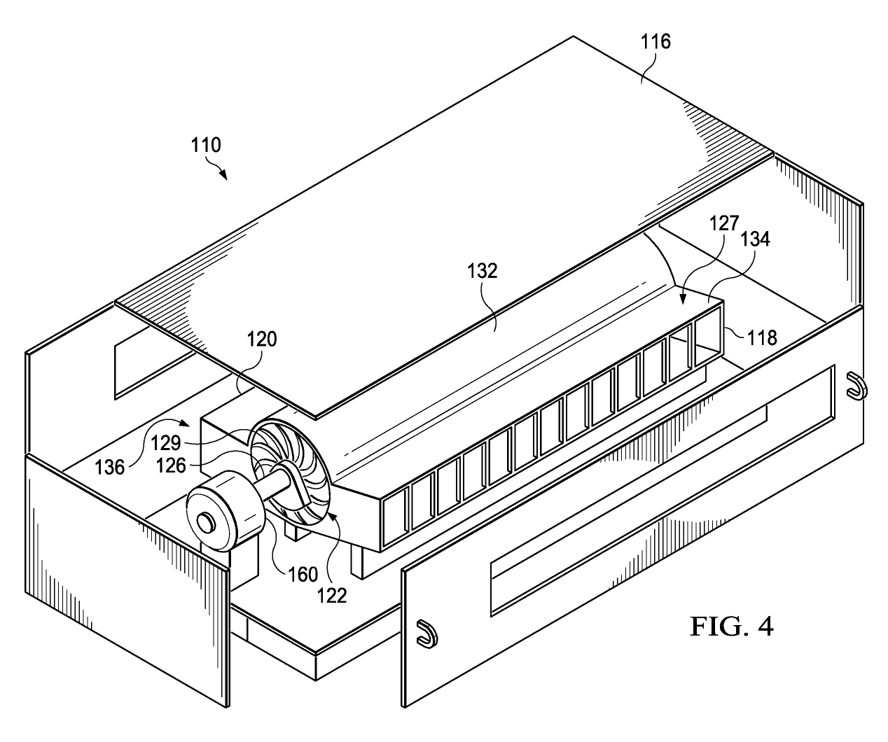

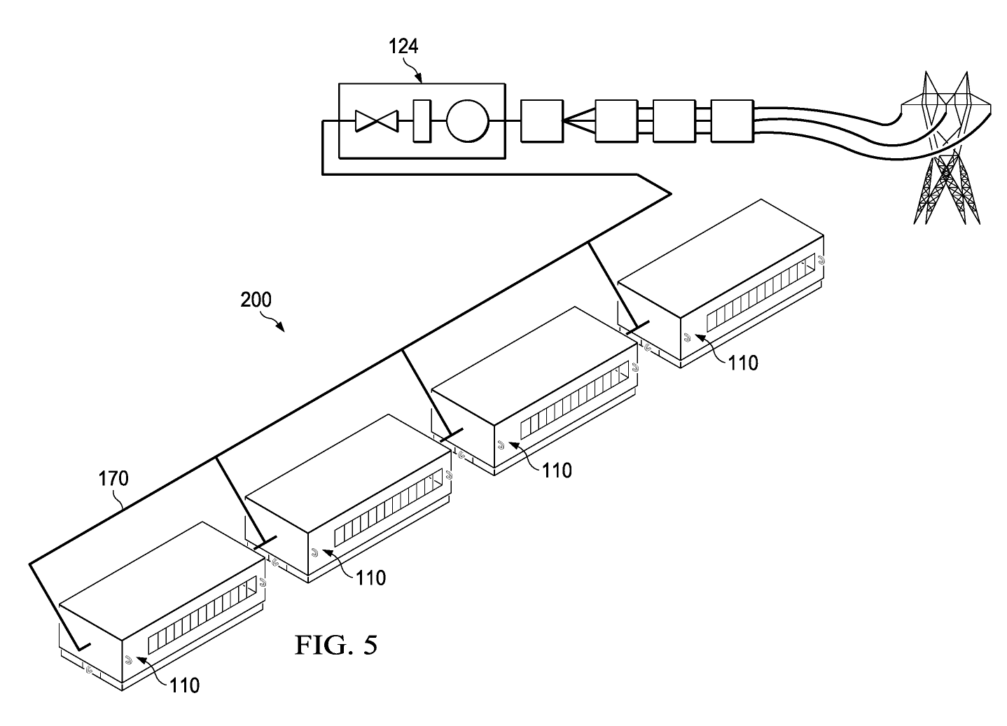

Referring to FIG. 4, an alternate embodiment of a HPPM module 110 is shown. The HPPM module 110 can include a protective enclosure 116, a turbine 122, and a fluid pump 160. The turbine 122 can include any number of blades 129 that can project radially outward from a central shaft 126. The hydraulic pump 160 can be used to pump high pressure liquids, such as biodegradable, biologically inert, or non-compressible fluids, or combinations thereof, from the HPPM module 110 to a shore-based generator 124 (FIG. 5) or offsite generator positioned on the shoreline or at a distance from the pump module 110. The turbine 122 can be housed within a turbine housing 127 that can have a substantially tubular portion 132, an upper inlet portion 134, and a lower outlet portion 136. The substantially tubular portion 132 can be sized to accommodate any suitable turbine 122. The upper inlet portion 134 can include an upstream grate 118 and the lower outlet portion 136 can include the downstream grate 120. The HPPM module 110 configuration can include the central shaft 126 being connected to the hydraulic pump 160. Systems can be configured for screen or grate cleaning systems and can be back flushed with water and/or back flushed with air. It will be appreciated that the HPPM module 110 can also incorporate a water submersible electric generator.

Referring to FIG. 5, a plurality of modules, such as HPPM module 10 or HPPM module 110 can be coupled into a pressurized fluid system 200. In the illustrated system 200, the fluid pumps 160 from each of the pump modules 110 can form a plurality of circuits 170, where each fluid pump 160 can be connected to a header body. Fluid from the system 200 can be used to generate electricity from an offsite or shore-based generator system 124. The system 200 can include a single turbine powered pump system, a multiple pump system with combined header system, and can utilize any suitable flexible or rigid tubing or piping in any suitable configuration. In an example embodiment, the system 200 can include one or a plurality of pressure and/or flow regulators that can maintain a substantially constant rate of flow and/or pressure to a shore-based generator or turbine. The pressure and/or flow regulator can include ball valves, or the like, having any suitable dimensions and can include a variety of different sized ball valves. The one or a plurality of fluid pumps associated with the system 200 can pump fluid to a remote generator incorporating an internal inverter, a generator having a separate inverter, or is a pressure and/or fluid regular is used no inverter may be required. The circuits 170 can include any suitable fittings, tubing, connectors, or the like. In one embodiment, the system can incorporate a pre-configured IEEE 1547 standard (Institute of Electrical and Electronics Engineers, Standard 1547) compliment of components for grid connection. An electrical interconnection configuration can include frequency feedback from a grid, can be designed without frequency from a grid, or can be configured or optimized for micro-grid applications. In one embodiment, the plurality of circuits 170 can be attached to or embedded within a barrier, such as artificial barrier 50, which may help prevent the plurality of circuits 170 from becoming damaged and/or from causing damage.

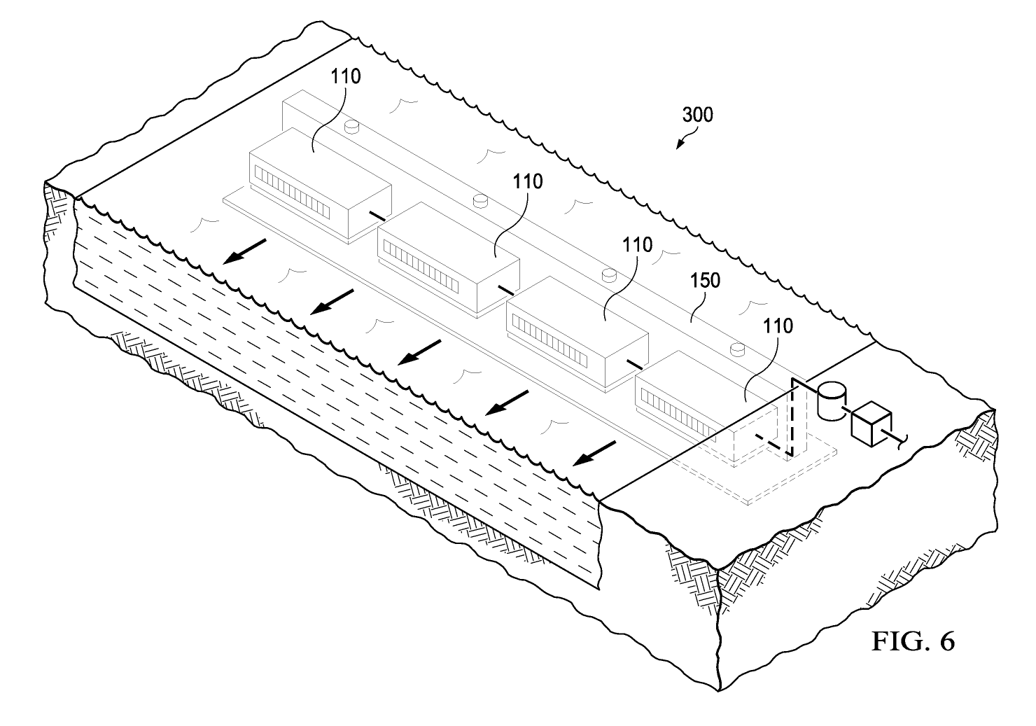

FIG. 6 illustrates a system 300 having a plurality of pump modules 110 in series attached to a single barrier 150 according to one embodiment. It will be appreciated that any suitable number, size, placement, and spacing of pump modules 110 (or generator modules 10) along a single barrier 150 is contemplated. It will be appreciated that multiple barriers can be associated with a single module, multiple modules can be associated with a single barrier, or modules described herein can be arranged in any other suitable configuration. As illustrated in FIG. 10, it may be advantageous to provide a first barrier and module upstream followed by a proximate second barrier and module downstream, where water passing through the first barrier and module can then pass through the second barrier and module without a significant decrease in the potential energy of the water flow. Such an arrangement of modules from upstream to downstream may allow multiple modules to use the same water flow to generate energy sequentially.

Systems described herein can generate a certain minimum amount of power even in low flow rate conditions. It will be appreciated that the artificial barrier 50 and associated generator module or pump module can be installed in a water channel or any waterway that did not previously have a dam, low head dam, or the like. The HPPM module 10 can be installed with an artificial barrier 50, for example, in any water channel that has a continuous or substantially continuous flow rate such as, for example, a river, stream, creek, or waste water treatment facility exit trough. Such a system can be useful to establish a minimum level of power production. This can be advantageous for the present system because renewable power sources are traditionally subject to a wide variability in minimum generation which can necessitate that utility companies maintain a large reserve of generating capacity. For example, a utility company that operates a wind farm may have to maintain a coal plant in ready status in case the wind farm becomes inoperable due to falling wind speeds. Power generated through the systems depicted herein may negate this issue by providing a base amount of power.

In one embodiment, a generator module or pump module, such as HPPM module 10 or pump module 110, can continue to generate electricity when tail water is at the same level as head water, or zero head. Conventional pressure-driven hydroelectric designs may not generate any electricity during such configurations, which may minimize their overall efficiency and effectiveness. Additionally, such configurations may allow for the generator modules 10 or pump modules 110 and artificial barriers 50 to be installed in wide variety of waterways, where such installation may not adversely impact boating, aquatic wildlife, or the like.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A hydroelectric system comprising:
(a) a module including;
(i) a protective housing,
(ii) a turbine housing retained within the protective housing, the turbine housing including an inlet at a first end, a substantially tubular portion, and an outlet at a second end;
(iii) a turbine retained at least partially within the turbine housing, the turbine including a plurality of blades coupled with a central shaft; and
(iv) a hydraulic pump, the hydraulic pump being coupled with the central shaft, wherein the hydraulic pump is configured to pump a high pressure liquid; and
(b) an artificial barrier, the module being coupled to a downstream surface of the artificial barrier, wherein the artificial barrier defines a cutout having an inlet portion, an outlet portion, and a channel fluidly coupled with the turbine housing of the module.

2. The hydroelectric system of claim 1, wherein the inlet portion of the cutout and the outlet portion of the cutout are identically sized.

3. The hydroelectric system of claim 1, wherein the module includes a protective screen.

4. The hydroelectric system of claim 1, further comprising an upstream grate positioned over the inlet portion of the cutout.

5. The hydroelectric system of claim 1, wherein the artificial barrier partially defines a first gap and a second gap.

6. The hydroelectric system of claim 1, wherein the turbine comprises from six to forty blades.

7. The hydroelectric system of claim 1, wherein the turbine rotates at less than sixty rotations per minute under all flow conditions.

8. The hydroelectric system of claim 1, further comprising a regulator that maintains the high pressure liquid at a constant flow and pressure such that an offsite generator is operated at a constant rate.

9. The hydroelectric system of claim 8, wherein the offsite generator does not require an inverter.

10. The hydroelectric system of claim 1, wherein the artificial barrier is a concrete wall.

11. The hydroelectric system of claim 1, further comprising a plurality of modules associated with the artificial barrier.

12. The hydroelectric system of claim 11, wherein the plurality of modules are arranged in series.

13. A hydroelectric system comprising:
(a) a module including;
(i) a turbine housing, the turbine housing including an inlet at a first end, a substantially tubular portion, and an outlet at a second end;
(iii) a turbine retained at least partially within the turbine housing, the turbine including a plurality of blades coupled with a central shaft; and
(iv) a hydraulic pump, the hydraulic pump being coupled with the central shaft, wherein the hydraulic pump is operably configured to pump a high pressure liquid; and
(b) an artificial barrier, the module being coupled to a downstream surface of the artificial barrier, wherein the artificial barrier defines a cutout having an inlet portion, an outlet portion, and a channel fluidly coupled with the turbine housing of the module.

14. The hydroelectric system of claim 13, wherein the module includes a protective screen material.

15. The hydroelectric system of claim 13, further comprising an upstream grate positioned over the inlet portion of the cutout.

16. The hydroelectric system of claim 13, wherein the artificial barrier partially defines a first gap and a second gap.

17. The hydroelectric system of claim 13, further comprising a plurality of hydraulically connected modules associated with the artificial barrier or a plurality of artificial barriers, wherein each of the plurality of hydraulically connected modules are coupled to generate power.

18. A method for operating a hydroelectric system comprising:
providing a module including;
(a) a protective housing,
(b) a turbine housing retained within the protective housing, the turbine housing including an inlet portion at a first end, a substantially tubular portion, and an outlet portion at a second end;
(c) a turbine retained at least partially within the turbine housing, the turbine including a plurality of blades coupled with a central shaft; and
(d) a hydraulic pump, the hydraulic pump being coupled with the central shaft, wherein the hydraulic pump is configured to pump a high pressure liquid; and
providing an artificial barrier, wherein the artificial barrier defines a cutout having an inlet portion, an outlet portion, and a channel;
positioning the module adjacent a downstream surface of the artificial barrier such that the turbine housing of the module if fluidly coupled with the channel of the cutout;
rotating the turbine with a fluid flowing through the cutout in the artificial barrier; and
generating electrical power in response to rotation of the turbine.

19. The method of claim 18, further comprising a plurality of modules associated with the artificial barrier.

20. The method of claim 18, wherein the turbine can be controlled to rotate at less than sixty rotations per minute under all flow conditions.
